(19) United States
(12) Patent Application Publication
(10) Pub. No.: US 2025/0371962 A1
(43) Pub. Date: Dec. 4, 2025

(54) Alerting method in the event of failure of an energy production device and associated electronic device

(71) Applicant: ORANGE, ISSY-LES-MOULINEAUX (FR)

(72) Inventors: David EXCOFFIER, CHATILLON CEDEX (FR); Wided HAMMEDI, CHATILLON CEDEX (FR)

(21) Appl. No.: 19/215,456

(22) Filed: May 22, 2025

(30) Foreign Application Priority Data
May 31, 2024 (FR) FR2405718

(51) Int. Cl. G08B 21/18; H02S 50/00

(52) U.S. Cl. CPC G08B 21/185; H02S 50/00

(57) ABSTRACT

An alerting method implemented by an electronic supervision device connected to an energy production device. In the method, a determination, by a deviation cause classification model taking as input a history of deviations between a value representative of a prediction of an amount of energy produced by the energy production device and a value representative of an amount of energy actually produced by the energy production device, of an occurrence of a failure in at least one component of the energy production device. An alert is generated according to which at least one component of the energy production device is defective.

### CROSS REFERENCE TO RELATED APPLICATION

The present application claims priority to French Patent Application No. FR2405718 filed on May 31, 2024, the content of which is incorporated herein by reference in its entirety.

### TECHNICAL FIELD

The disclosed technology belongs to the general field of energy production systems. The invention more particularly relates to an alerting method in the event of failure of an energy production device. It also relates to an electronic device configured to implement such a method.

It may for example find an application as part of energy production systems using one or more renewable energy sources or combining renewable energy sources and energy sources called “conventional” energy sources, for example a fossil or nuclear energy source.

### BACKGROUND

The rise of renewable energies, among which photovoltaic and wind power occupy a prominent place, is a major economic and societal evolution of recent decades. However, controlling the amount of energy produced and the maintenance costs of these energy production systems proves to be more complex than for a conventional installation that operates in a perfectly controlled environment. A conventional installation, as opposed to an installation considering one or more of the renewable energy sources, relies for example on a fossil or nuclear energy source.

It is the very nature of energy production systems from renewable energy sources that explains this complexity. Indeed, the amount of energy, for example produced by a wind farm or a photovoltaic solar power plant, is in particular dependent on environmental hazards and/or aging phenomena of the components of these systems that are likely to occur over time.

When the considered energy production system consists of one or more photovoltaic panels, these aging phenomena may for example correspond to a delamination, a degradation of the anti-reflection layer of the glass or polymer covering the panel, a yellowing of the ethylene-vinyl acetate encapsulant, a generation of hot spots, a formation of cracks within photovoltaic cells, a generation of defects at the interconnections, a failure of a bypass diode and/or potential-induced degradation (PID). These aging phenomena may lead to failures of various kinds, and possibly generate a degraded-mode operation, in particular when part of the photovoltaic cells of a panel is used.

To limit these failures or their impact, these energy production systems are regularly monitored by applying qualitative methods, including visual tests or infrared and/or electroluminescence measurements, for example carried out by experts and/or drones. However, these operational maintenances generate significant costs (for example 8,000 8000 €/MWc/year for a ground-mounted photovoltaic solar power plant). Furthermore, the degradations and losses of performance are generally detected late and their severity is poorly estimated. As a result, these energy production systems using one or more renewable energy sources often have an actual production lower than their optimal production.

### SUMMARY

Embodiments of the present disclosure aim to overcome all or part of the drawbacks of the prior art, in particular those set out above, by proposing a solution that allows determining a cause of a decreased energy production, and generating an alert when this cause is related to a failure in one or more components of the energy production device.

To this end, and according to a first aspect, the disclosed technology relates to an alerting method implemented by an electronic supervision device connected to at least one energy production device, the method comprising:
a determination, by a deviation cause classification model taking as input a history of deviations between a value representative of a prediction of an amount of energy produced by the energy production device and a value representative of an amount of energy actually produced by the energy production device, of an occurrence of a failure in at least one component of said energy production device; and
a generation of an alert according to which at least one component of said energy production device is defective.

In other words, the deviation cause classification model determines that the deviations from the history are caused by a failure in one or more components of the energy production device.

By “energy production device” it is meant an energy production device using one or more renewable energy sources or combining one or more renewable energy sources and one or more sources called “conventional” energy sources, such as fossil or nuclear energy sources.

By “failure in at least one component” it is meant a malfunction (sudden or not) of one or more components of the energy production device, or even of the entire energy production device, which then no longer produces electrical energy.

The “amounts of energy” predicted or actually produced are expressed for example in the form of electrical power, or voltage and/or current.

As discussed below, the amount of energy produced is for example predicted by an energy prediction model, and the energy prediction and deviation cause classification models correspond to machine learning models.

Generally, it is considered that the steps of a method should not be interpreted as being related to a notion of temporal succession.

In some modes of implementation, the alerting method may further include one or more of the following characteristics, taken individually or in all technically possible combinations.

In some modes of implementation, the generation of an alert corresponds to a generation of an alert message intended to inform a user that at least one component of said energy production device is defective.

In some modes of implementation, this alert message is transmitted, via a communication interface, to a remote monitoring device. As a variant, the electronic supervision device according to the disclosed technology comprises a human-machine interface, such as a touch screen, and the alert message is displayed on this screen. This alert message for example comprises an identification of the defective energy production device, and possibly the defective component(s).

In some modes of implementation, the alert is generated after a certain number of failure occurrences is reached. When the alert message is transmitted to a remote monitoring device, such a mode of implementation can help limit the transmission of messages and therefore prevent congestion in the telecommunications network linking the electronic supervision device to the remote monitoring device.

In some modes of implementation, the value representative of a prediction of an amount of energy produced by the energy production device is determined by an energy prediction model.

These prediction and classification models correspond to machine learning models. In some modes of implementation, the deviation cause classification model and/or the energy prediction model are multi-input (linear or non-linear) regression models.

Each of the energy prediction and/or deviation cause classification models can be implemented on a single electronic device, or be distributed across multiple electronic devices connected to each other.

In some modes of implementation, the energy prediction and/or deviation cause classification models are implemented in the form of neural networks (convolution, perceptron, auto-encoder, recurrent, etc.). According to one particular implementation, the considered neural networks are recurrent neural networks of the “long short-term memory” (LSTM) type.

Furthermore, it is important to note that no limitation is attached to the type of training technique used to obtain the energy prediction model. Any technique implementing a learning algorithm (machine learning) and providing, as output, a prediction of an amount of energy produced given environmental data corresponding to input data, can be considered within the context of the disclosed technology (for example, support vector machine, logistic regression, etc.). In other words, the energy prediction model is independent of the training method considered to train this model.

Similarly, no limitation is attached to the type of training technique used to obtain the deviation cause classification model. Any technique implementing a learning algorithm (machine learning) and providing, as output, a probability that a certain cause has generated deviations given a history of deviations (corresponding to input data), can be considered within the context of the disclosed technology (for example, support vector machine, logistic regression, etc.). In other words, the deviation cause classification model is independent of the training method considered to train this model.

Moreover, any training criterion known to those skilled in the art can be considered during the training phase of these machine learning models, such as the least squares method or cross-entropy minimization.

In some modes of implementation, the history of deviations comprises only deviations greater than a first value.

In some modes of implementation, the alerting method further comprises a comparison of a deviation with the first value, and an addition of said deviation to the history of deviations, based on the result of said comparison.

In some modes of implementation, the comparison is implemented at a constant frequency.

In some modes of implementation, the deviation cause classification model is configured to determine whether the deviations are caused by an evolution in environmental data of the energy production device, by a change of at least one sensor for measuring said environmental data, by a change of at least one component of the energy production device, or by a failure in at least one component of said energy production device.

As mentioned previously, the steps of adapting the classification model and of generating an alert are implemented when the determined cause of these deviations is a failure in at least one component of said energy production device.

By “environmental data” it is meant any data relating to the environment of the energy production device that is likely to influence the amount of energy produced by this device. As mentioned below, this may for example include meteorological data and/or geographical data (position, orientation, etc.).

In some modes of implementation, the energy production device comprises at least one photovoltaic cell and the environmental data correspond to at least one among: a data representative of solar radiation on said cell (such as luminance and/or radiance), a data representative of a temperature of said cell, a data representative of a humidity level, a data representative of a wind speed, a data representative of an orientation of the cell, a data representative of a geographical position of the cell, and/or a combination of at least two of the environmental data above.

In some modes of implementation, the energy production device comprises a photovoltaic solar panel, a photodiode and/or a phototransistor.

In some modes of implementation, the deviation cause classification model is further configured to determine a type of failure and/or said at least one defective component.

In some modes of implementation, the method further comprises an adaptation of the deviation cause classification model, and this adaptation corresponds to a re-training of the deviation cause classification model.

In some modes of implementation, an adaptation is performed after each determination of an occurrence of a failure in a component. The adaptation step is then for example implemented in response to this determination of a failure, and the model is re-trained so as to no longer consider the photovoltaic panel as operating in degraded mode, even if one or more components of this photovoltaic panel are defective and induce a decrease in terms of electricity production. As a variant, the adaptation is performed after several failures (for example, when a certain number n of failures (n>1) is reached).

In some modes of implementation, the method further comprises:
a determination, by said classification model, that new deviations are caused by an evolution in environmental data of the energy production device, a change of at least one sensor for measuring said environmental data and/or a change of at least one component of the energy production device; and,
a re-training of the energy prediction model.

In some modes of implementation, the value representative of a prediction of an amount of energy produced by the energy production device is determined by an energy prediction model, and the method further comprises a determination of a size of the history based on the deviation cause classification model, for example based on its accuracy and/or on the computational and/or storage capabilities of a device on which this model is (at least partially) installed.

In some modes of implementation, the size of the history is determined based on resources accessible by this electronic supervision device. These resources correspond for example to resources in terms of computation/processing and/or to resources in terms of storage.

In some modes of implementation, the value representative of a prediction of an amount of energy produced by the energy production device is determined by an energy prediction model, and the method further comprises a training of the energy prediction model from environmental data sets of said energy production device and from values representative of an amount of energy actually produced by the energy production device considering said environmental data sets, the training of the energy prediction model being implemented when none of the components of said energy production device is defective or considered to be defective.

In some modes of implementation, the method further comprises a training of the deviation cause classification model from a plurality of histories of deviations between a value representative of a prediction of an amount of energy produced by the energy production device and a value representative of an amount of energy actually produced by the energy production device, each of the histories of the plurality of histories being associated with a label corresponding to a cause of said deviations.

In some modes of implementation, the energy prediction model corresponds to a recurrent neural network including layers called “low” layers, the training of the energy prediction model being implemented in a learning environment distinct from an operating environment, and the adaptation step further comprises a partial re-training of the energy prediction model in the operating environment by freezing the low layers of the recurrent neural network.

According to a second aspect, the present application relates to an electronic supervision device configured to implement an alerting method of the present application.

According to the modes of implementation, the device may in particular be configured to implement any one of the modes of implementation of the alerting method of the present application.

According to a third aspect, the present application relates to a system comprising an energy production device and the electronic supervision device according to the second aspect.

According to a fourth aspect, the present application relates to a computer program including instructions for the implementation of an alerting method, when said program is executed by a processor.

According to the modes of implementation, the computer program may in particular include instructions for the implementation of any one of the modes of implementation of the alerting method of the present application.

This program may use any programming language, and may be in the form of source code, object code or intermediate code between source code and object code, such as in a partially compiled form or in any other desirable form.

According to a fifth aspect, the disclosed technology relates to a computer-readable recording medium on which a computer program according to the present application is recorded.

The information or recording medium may be any entity or device capable of storing the program. For example, the medium may include a storage means such as a ROM for example a CD-ROM or a microelectronic circuit ROM, or a magnetic recording means, for example a hard disk.

On the other hand, the information or recording medium may be a transmissible medium such as an electrical or optical signal, which may be conveyed via an electrical or optical cable, by radio or by other means. The program according to the disclosed technology can particularly be downloaded from an Internet-type network.

Alternatively, the information or recording medium can be an integrated circuit in which the program is incorporated, the circuit being adapted to execute or to be used in the execution of the method in question.

### BRIEF DESCRIPTION OF THE DRAWINGS

Other characteristics and advantages of the present disclosed technology will emerge from the description given below, with reference to the appended drawings which illustrate one exemplary embodiment thereof without any limitation. In the figures:

FIG. 1A is a first example of a system in which an alerting method in the event of failure of an energy production device can be implemented;

FIG. 1B is a second example of a system in which an alerting method in the event of failure of an energy production device can be implemented;

FIG. 2 represents modules embedded in an electronic supervision device according to one exemplary implementation of the disclosed technology;

FIG. 3 schematically represents one example of hardware architecture of an electronic supervision device;

FIG. 4 represents, in the form of a flowchart, one particular mode of implementation of an alerting method in the event of failure of an energy production device, for example executed by the electronic supervision device of FIG. 2; and

FIG. 5 represents, in the form of a flowchart, one particular mode of implementation of an alerting method in the event of failure of an energy production device, for example executed by the electronic device of FIG. 2. FIG. 5 is a detailed version of the alerting method illustrated with reference to FIG. 4.

FIG. 6 illustrates one example of learning data of the deviation cause classification model.

### DESCRIPTION OF ILLUSTRATIVE EMBODIMENTS

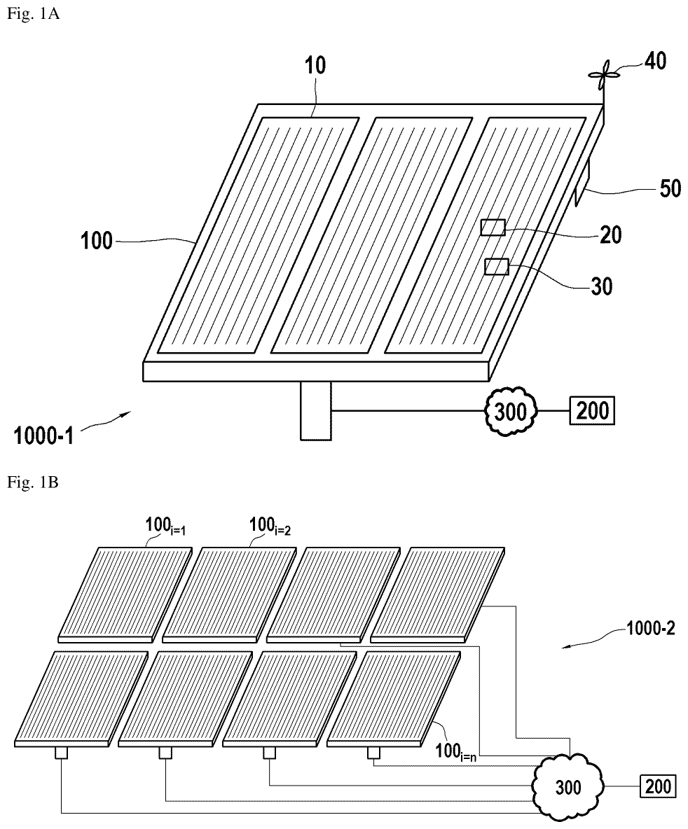

FIG. 1A is a first example of a system in which an alerting method in the event of failure of an energy production device can be implemented.

As illustrated in FIG. 1A, the energy production system 1000-1 comprises a photovoltaic panel 100. This photovoltaic panel 100 is for example fixed on a stand, disposed on a roof or integrated into a building. This photovoltaic panel 100 can also be integrated into a vehicle, such as an airplane, a boat or a train. The electricity produced by a photovoltaic panel is generally in the form of direct current, and this electricity is for example directly used to power some industrial machines, recharge batteries, in particular electric vehicle batteries, or various other uses. The electricity produced by the photovoltaic panel 100 can also be converted into alternating current which, itself, can either be transmitted to the local or national electricity grid, or used locally.

The photovoltaic panel 100 comprises one or more photovoltaic modules 10, each photovoltaic module 10 itself being able to comprise one or a plurality of photovoltaic cells. In the present implementation, it is considered that the photovoltaic panel 100 includes three photovoltaic modules 10. It should however be noted that no limitation is attached to the number of photovoltaic modules 10. The following developments can indeed be easily generalized by those skilled in the art in case where a greater or lesser number of photovoltaic modules 10 is considered.

As illustrated by FIG. 1A, the photovoltaic panel 100 is equipped with environmental data measurement sensors:
a brightness sensor 20 configured to measure an amount of light and/or solar radiation reaching this sensor. According to one particular mode of implementation, the brightness sensor 20 carries out measurements in the ultraviolet, visible and infrared ranges, and covers for example a range from 280 to 950 nanometers (nm). As a variant, the brightness sensor 20 carries out measurements only in the visible range, and covers for example a range from 400 to 700 nm;
a temperature sensor 30 configured to measure the temperature reached by the photovoltaic panel 100 and/or the temperature in the vicinity of said photovoltaic panel 100 (for example, less than 10 meters from this panel);
an anemometer 40 installed on or in the vicinity of (for example, less than 10 meters) the photovoltaic panel 100, and which measures the speed and/or the pressure of the wind; this anemometer 20 can also be coupled to a wind vane (not represented) which determines the origin of this wind;
an inertial unit 50 which integrates for example a compass as well as a gyroscope. This inertial unit 50 can also integrate an accelerometer. In one particular mode of implementation, the compass, the gyroscope and the accelerometer can be “3-axis” instruments, which in particular make it possible to detect the impacts of hailstones on the photovoltaic panel 100ᵢ
a magnetometer; and/or
an inclinometer.

These different sensors of course constitute only one illustrative example, and the photovoltaic panel 100 may be equipped with only some of them or comprise sensors other than those mentioned above. The photovoltaic panel 100 may also comprise several sensors of the same type (for example several temperature sensors), positioned at different locations on the photovoltaic panel.

This solar panel and the sensors that equip it are connected, directly or through a telecommunications network 300, to an electronic supervision device 200 whose functionalities are described in more detail below.

FIG. 1B is a second example of a system 1000-2 in which an alerting method in the event of failure of an energy production device can be implemented. This second example differs mainly from the first example of FIG. 1A by the number of photovoltaic panels that make up the system.

As illustrated in FIG. 1B, the energy production system 1000-2 comprises a photovoltaic solar power plant, also called “solar farm”, including a plurality of photovoltaic panels 100_{i=1 . . . n} connected together in series and/or in parallel, and which can be connected to an electricity grid by inverters.

A photovoltaic solar power plant covers a surface typically ranging from one hectare to more than twenty square kilometers, and groups together a large number of solar panels, typically from several thousands or tens of thousands to more than one million.

The photovoltaic panels 100_{i=1 . . . n} are also equipped with sensor(s) similar to those described with reference to FIG. 1A. As a variant, only some of the photovoltaic panels 100_{i=1 . . . n} are equipped with sensors.

As illustrated in FIG. 1B, these solar panels and the sensors that equip them are connected, directly or through a telecommunications network 300, to an electronic supervision device 200 whose functionalities are described in more detail below. Thus, as illustrated in FIG. 1B, the architecture of the system 1000-2 is centralized, since in this example each of the solar panels 100_{i=1 . . . n} is connected to the electronic supervision device 200. As a variant, the architecture of the system 1000-2 is distributed, and the system 1000-2 comprises a plurality of electronic supervision devices 200 that can be connected to one or more solar panels.

According to one variant, the photovoltaic panels 100_{i=1 . . . n} can be grouped into set(s) of panels, at least one panel (for example each panel) of at least one set of panels (for example of each set of panels) being connected on the one hand to a first electronic supervision device denoted A responsible for supervising only this photovoltaic panel, and on the other hand to a second electronic supervision device denoted B responsible for supervising several photovoltaic panels of this set. In some implementations, these sets can form a partition (in terms of panels) of the system (and therefore be disjointed).

In some implementations, these sets of panels may have some panels in common. For example, a first division into first sets of panels of the same size (for example, sets of 10 panels) may be carried out, each first set being supervised by a different supervision device, followed by a second division into second sets of panels supervised by other supervision devices (for example, sets as a function of the physical implementation of the panels, for example, grouping the panels per row and/or per column, and/or per orientation of their sensors relative to the sun, etc.).

Each first electronic supervision device A (“unitary” supervision of a single panel) is then for example configured to collect the measurements from a first set of sensors of the single photovoltaic panel that it supervises. The second electronic supervision device B (processing for example information relating to several panels) makes it possible either to collect, among other things, the measurements of a second set of sensors of this photovoltaic panel (different from the first set of sensors, but which may have sensors in common with this first set of sensors), or to recover the information from at least two (for example each) unitary electronic supervision devices A in order to derive other abacuses (e.g.: average production of a subset of photovoltaic panels 100_{i=1 . . . n}. This configuration offers the advantage of helping to obtain statistics on the unitary failures (i.e. detected on a specific photovoltaic panel) and to evaluate the impact of unitary failures on all the panels measured by B (for example when these failures are correlated). For example, a supervision device A makes it possible to identify a defective panel, a supervision device B making it possible to estimate the impact of this failure on the production of the park (and therefore to evaluate the urgency of replacing or repairing the defective panel).

Depending on the implementations, the exchanges of information between the “unitary” supervision devices and the supervision devices processing the information relating to several panels can be done either by wired communication or by wireless communication (Wi-Fi for example).

It should be noted that the system may comprise, in some implementations, a hierarchical structure with several stages (for example three or more) between supervision devices.

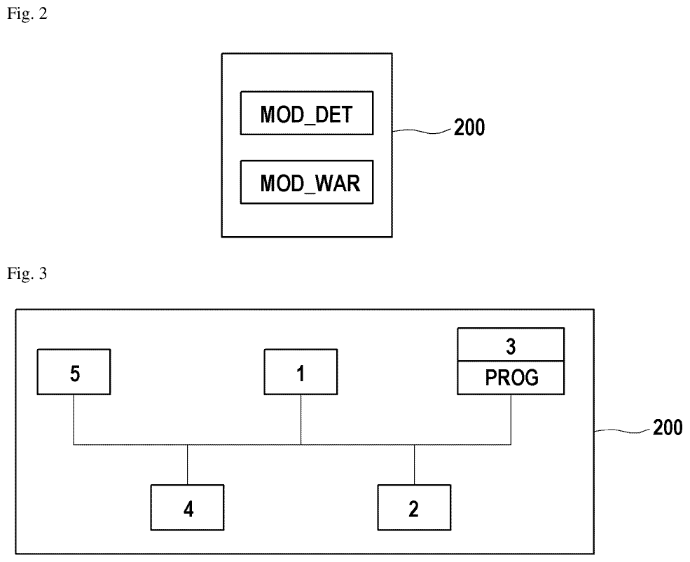

FIG. 2 represents modules embedded in an electronic supervision device 200 according to one exemplary implementation of the disclosed technology.

As illustrated in FIG. 2, the electronic supervision device 200 comprises in particular:
a determination module MOD_DET including a deviation cause classification model taking as input a history of deviations between a value representative of a prediction of an amount of energy produced by the energy production device (100, 100ᵢ) and a value representative of an amount of energy actually produced by the energy production device (100, 100ᵢ), and providing as output a cause of these deviations; and
a module MOD_WAR for generating an alert according to which at least one component of the energy production device is defective, this module being activated when the cause is a failure in at least one component of the energy production device.

Their functionalities are described in more detail below with reference to different modes of implementation.

FIG. 3 schematically represents one example of hardware architecture of an electronic supervision device 200.

As illustrated in FIG. 3, the electronic supervision device 200 has the hardware architecture of a computer. Thus, the electronic supervision device 200 includes, in particular, a processor 1, a random access memory 2, a read-only memory 3 and a non-volatile memory 4. It also has communication means 5.

The read-only memory 3 of the electronic supervision device 200 constitutes a recording medium in accordance with the disclosed technology, readable by the processor 1 and on which a computer program PROG in accordance with the disclosed technology is recorded, including instructions for the execution of steps of the alerting method according to the disclosed technology. The program PROG defines functional modules of the electronic supervision device 200, which rely on or control the hardware elements 1 to 5 of the electronic supervision device 200 mentioned above. These functional modules are illustrated in FIG. 2 in a non-limiting manner, and are described in more detail below with reference to different modes of implementation.

In some modes of implementation, the communication means 5 allow in particular the electronic supervision device 200 to obtain values representative of amounts of energy actually produced by the energy production device(s) 100, 100ᵢ, but also values representative of environmental data from the energy production device. For this purpose, the communication means 5 include a wired or wireless communication interface able to implement any suitable communication protocol.

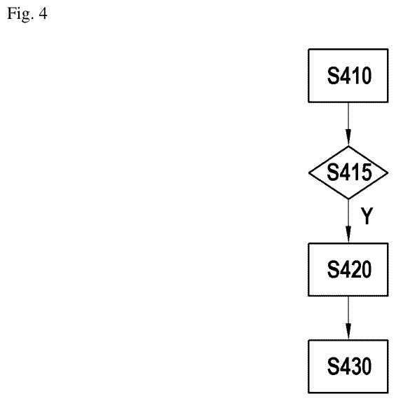

FIG. 4 represents, in the form of a flowchart, one particular mode of implementation of an alerting method in the event of failure of an energy production device, for example executed by the electronic supervision device of FIG. 2.

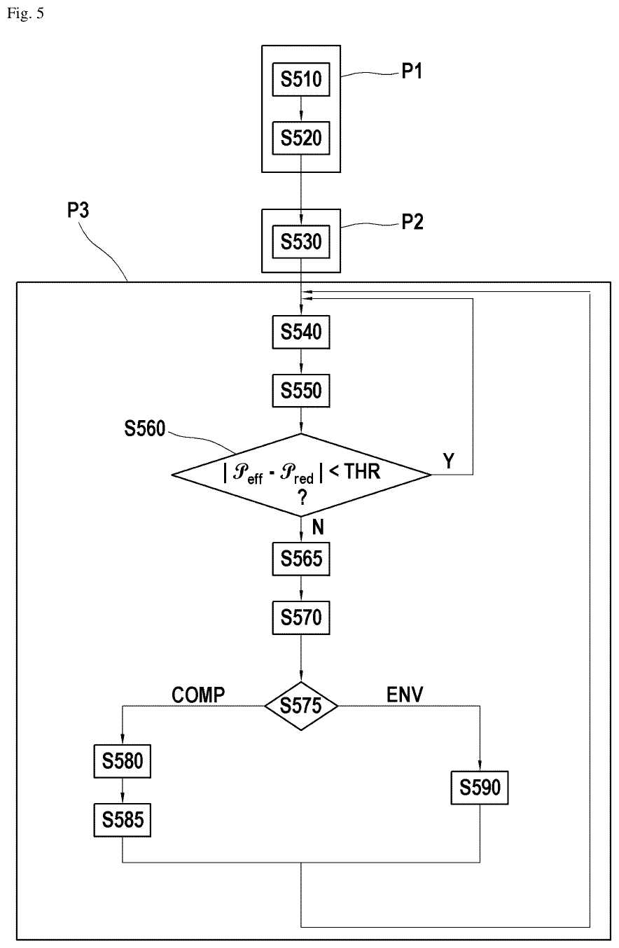

In the present mode of embodiment, the alerting method includes a first step S410 during which the cause of deviations between a value representative of a prediction of an amount of energy produced by the energy production device 100, 100ᵢ and a value representative of an amount of energy actually produced by the energy production device 100, 100ᵢ is determined. This step is for example implemented by the module MOD_DET of the electronic supervision device 200. One exemplary implementation of this step S410 is described in more detail with reference to step S570 of FIG. 5.

The alerting method further comprises a step S415 during which it is determined whether these deviations are caused by a failure in at least one component of said energy production device 100, 100ᵢ. One exemplary implementation of this step S415 is described in more detail with reference to step S575 of FIG. 5.

If this is the case (selection “Y”), a step S420 is implemented during which the deviation cause classification model is adapted, so as to no longer consider the photovoltaic panel as operating in degraded mode, even if one or more components of this photovoltaic panel are defective and induce a decrease in terms of electricity production (i.e. the current operation, due to at least one a priori defective component, becomes the reference operation (with respect to which a deviation must be detected) for the classification model). In this way, if new deviations are detected during a next iteration, their cause could be determined independently. This step S420 is for example implemented by the module MOD_RET of the electronic supervision device 200. One exemplary implementation of this step S420 is described in more detail with reference to step S550 of FIG. 5.

The method further comprises a step S430 during which an alert is generated which aims to warn that at least one component of said energy production device 100, 100ᵢ is defective. This step S430 is for example implemented by the module MOD_WAR of the electronic supervision device 200. One exemplary implementation of this step S430 is described in more detail with reference to step S585 of FIG. 5.

FIG. 5 represents, in the form of a flowchart, one particular mode of implementation of an alerting method in the event of failure of an energy production device, for example executed by the electronic device 200 of FIG. 2. FIG. 5 is a detailed version of the alerting method illustrated with reference to FIG. 4.

The alerting method firstly comprises a first phase P1, called “training phase”, during which the prediction and classification models used as part of this alerting method are trained in a learning environment. This first phase P1 includes steps S510 and S520 and can be implemented either by the electronic supervision device 200 or by a distinct electronic device. The method further comprises a step P2 including a step S530 during which the models previously trained in the learning environment are transferred to an environment called “operating environment.” Finally, the alerting method comprises a third phase P3, called operating phase, which includes steps S540 to S590 described below.

As illustrated in FIG. 5, the alerting method comprises a first step S510 during which an energy prediction model is trained. This energy prediction model is intended to predict an amount of energy produced by an energy production device, such as the devices 100, 100ᵢ of FIGS. 1A and 1B. According to one particular implementation, this prediction model is implemented using an artificial neural network, such as a recurrent neural network. This recurrent neural network corresponds for example to an LSTM type network.

This energy prediction model is trained with learning data comprising environmental data sets, each set being associated with an amount of energy produced. In other words, the amount of energy produced designates the amount of energy actually produced by the energy production device 100, 100ᵢ in one particular context defined by the associated environmental data.

The energy production device 100, 100ᵢ mentioned above corresponds for example to a photovoltaic panel, and these environmental data correspond for example to a data representative of solar radiation on this panel, of a temperature of this panel, of a surrounding humidity level, of a wind speed, of an orientation of this panel, and/or of a geographical position of this panel.

It is important to note that in some modes of implementation, the training S510 of the energy prediction model is carried out when none of the components of said energy production device 100, 100ᵢ is defective or considered as such. In this way, the training focuses on correlating only environmental data with amounts of energy produced, and the risk of introducing biases is then reduced.

The alerting method further comprises a step S520 during which a deviation cause classification model is trained. According to one particular implementation, this classification model is implemented using an artificial neural network, such as a recurrent neural network. This recurrent neural network corresponds for example to an LSTM type network. In one particular mode of embodiment, this deviation cause classification model is intended to determine whether deviations between a predicted amount of energy and an amount of energy actually produced by the energy production device 100, 100ᵢ are caused:
either by a failure in one or more components of the energy production device 100, 100ᵢ,
or by an evolution in the environmental data of the energy production device (100, 100ᵢ), by a change of at least one sensor for measuring said environmental data, and/or by a change of at least one component of the energy production device 100, 100ᵢ.

The “change of at least one sensor” corresponds, for example, to a replacement of one or more sensors, and/or to an evolution in the measurement capabilities of one or more sensors, then resulting in a drift (for example, due to aging). The “change of at least one component” of the energy production device corresponds for example to a replacement of one or more components of the energy production device and/or to an evolution in the capabilities of one or more components of the energy production device. Thus, the photovoltaic cells for example experience reduced capabilities when covered with dust, dead leaves, or bird droppings.

To do so, the classification model is trained with learning data consisting of sets of histories of deviations associated with causes of deviations. More specifically, a history of deviations designates a temporal sequence of deviations between a value representative of a prediction of an amount of energy produced by the energy production device (100, 100ᵢ) and a value representative of an amount of energy actually produced by the energy production device (100, 100ᵢ), and each history is associated with a “cause” having generated the deviations of this sequence.

According to one particular implementation, the cause relating to the failure in one or more components of the energy production device is represented by the label “L_{CD}”, and the other causes (for example, the evolution in the environmental data, the change of at least one measurement sensor or the change of component) are represented by the label “L_{DD}”.

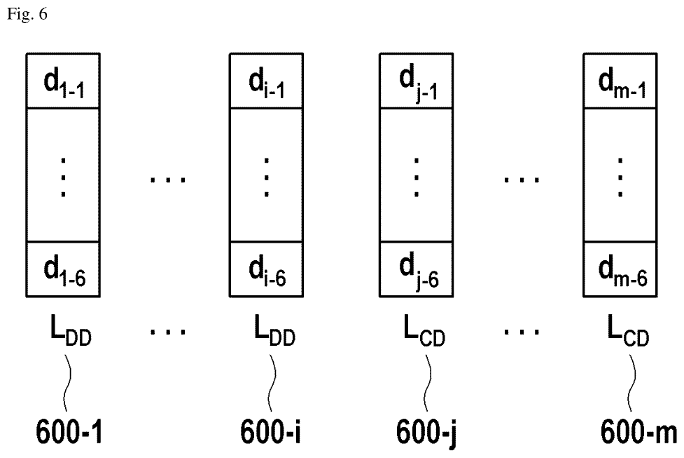

FIG. 6 illustrates one example of learning data for the deviation cause classification model.

As illustrated in FIG. 6, these learning data comprise histories of deviations 600-1, . . . , 600-i, 600-j, . . . , 600-n, each associated with a cause L_{CD}, L_{DD} that generated these deviations. The history of deviations 600-1 consists of a temporal sequence of deviations d₁₋₁, . . . , d₁₋₆ and is associated with the label “L_{DD}”, the history of deviations 600-i consists of a temporal sequence of deviations dᵢ₋₁, . . . , dᵢ₋₆ and is associated with the label “L_{DD}”, the history of deviations 600-j consists of a temporal sequence of deviations dⱼ₋₁, . . . , dⱼ₋₆, and is associated with the label “L_{CD}”, and the history of deviations 600-n consists of a temporal sequence of deviations dₙ₋₁, . . . , dₙ₋₆ and is associated with the label “L_{CD}”.

To acquire these learning data, evolutions in the environmental data and failures in one or more components are for example simulated. For each of these situations, the energy prediction model (now trained) predicts, at different instants t₁ . . . t₆, an amount of energy produced by the energy production device. Then the difference between the predicted amount of energy and the amount of energy actually produced by the device is then recorded in a data structure, with the label (e.g., L_{CD}, L_{DD}) representative of the cause that generated these differences. This data structure corresponds for example to an ordered list.

As illustrated in FIG. 6, each of the histories comprises six deviations associated with six different instants. It should however be noted that no limitation is attached to the size of these histories. The following developments can indeed be easily generalized by those skilled in the art to a case where a different size is considered. Furthermore, in one particular mode of implementation, an optimal history size is determined, prior to step S520 previously mentioned.

To do so, a size range is determined, for example based on resources of the electronic device (200) or resources accessible by this electronic device (200). By “resource” it is meant hardware resources (for example, the memory) and/or processing resources (for example, in terms of capability and/or processing time). Then, different history sizes of this range are considered, and their accuracy is determined.

More specifically, the deviation cause classification model is applied several times, considering different history sizes. Then the combination {size; accuracy obtained with this size} is recorded. Depending on one particular implementation, a range of sizes to be tested is determined, for example based on previously obtained history data. The limits of this range are for example defined based on the minimum and maximum duration of the deviations from this history related to an evolution in the environmental data. As a variant or in combination, the maximum limit is determined based on the accessible resources. These resources may correspond to computing capabilities accessible by or specific to the electronic supervision device (a large size can generate a very long response time) and/or memory capabilities of this electronic device.

Finally, a history size which corresponds for example to the one offering the best accuracy is selected.

This determination and use of the history size can be advantageous since it results from a compromise between the resources in terms of processing and/or memory specific to or accessible by the electronic supervision device, and the accuracy of the model.

Returning to FIG. 5, the alerting method further comprises a step S530 during which the evaluation and classification models previously trained in the learning environment are transferred to an operating environment distinct from the learning environment.

If the training of these two models had not previously been implemented by the electronic supervision device 200, they are then received by this electronic supervision device 200, for example via the communication means 5.

In one particular mode of implementation, step S530 comprises a partial re-training of the energy prediction model, so as to adapt to the environment in which the considered energy production device is installed.

As mentioned previously, this energy prediction model corresponds for example to a neural network, and includes layers called “low” layers encoding generic characteristics, such as generic relations between an amount of electricity generated by a photovoltaic panel and solar radiation reaching this panel. In some modes of implementation, the re-training can be “partial” in the sense that these “low” layers are frozen, and the gradient computation and the back-propagation are then disabled for these layers. This characteristic is advantageous in that it helps reduce the risks of overfitting of the prediction model. Moreover, the phase of re-training the prediction model is lighter and less resource-intensive (storage and/or processing).

The alerting method comprises a third phase P3, called operating phase, which includes steps S540 to S590. This phase aims to determine the causes relating to an energy production decrease and, if necessary, to adapt the learning models following this determination.

During step S540, the electronic supervision device 200 receives, from the energy production device it manages, environmental data and an amount of energy P_{eff} actually produced during a time interval (defined for example by parameterization), considering these environmental data. These data are for example received using the communication means 5 previously mentioned.

The alerting method further comprises a step S550, during which an amount of energy P_{pred} likely to have been produced by this energy production device during the same time interval as the one mentioned with reference to step S540 and this by taking into account the environmental data obtained in step S540, is predicted by the energy prediction model.

Then, during a step S560, it is determined whether the deviation corresponding to the difference between the amount of energy P_{eff} actually produced and the amount of energy P_{pred} is smaller than a value THR, called “first value”. If this is the case—e.g., if the deviation is smaller than the value THR-, this means that the deviation is not significant enough to reflect either a failure of the energy production device, or an evolution in the environmental data, a change of sensor, or a change of component. Consequently, the alerting method loops back to step S540 (selection “Y”).

If, on the other hand, the deviation is greater than or equal to the value THR, a step S565 is implemented during which the deviation is added to a history of deviations. According to one particular mode of implementation, this history is implemented as an ordered list.

In one particular mode of implementation, steps S540, S550 and S560 are implemented at a constant frequency.

When a stop condition is reached, for example when this history has reached a certain size (defined for example by parameterization), a step S570 is implemented during which the cause of the deviations is determined. This step S570 is for example implemented by the module MOD_DET of the electronic supervision device 200 which in particular comprises a deviation cause classification model.

In one particular mode of implementation, this deviation cause classification model is configured to determine whether deviations between a predicted amount of energy and an amount of energy actually produced by the energy production device 100, 100ᵢ are caused:
either by a failure in one or more components of the energy production device 100, 100ᵢ,
or by an evolution in the environmental data of the energy production device (100, 100ᵢ), by a change of at least one sensor for measuring said environmental data, and/or by a change of at least one component of the energy production device 100, 100ᵢ.

If it is determined in step S570 that the deviations are caused by a failure in one or more components of the energy production device 100, 100ᵢ (step S575, selection “COMP”), steps S580 and S85 are implemented by the electronic supervision device 200.

During step S580, the classification model is adapted so as to avoid repetitive alerts for the same cause, but also to allow the electronic supervision device 200 to be able to determine new deviations and causes of deviations. This step S580 is for example implemented by the module MOD_RET of the electronic supervision device 200. In one particular mode of implementation, this adaptation step corresponds to a re-training of this deviation cause classification model.

In the mode of implementation illustrated by this FIG. 5, the adaptation is performed after each determination of an occurrence of a failure in a component. The adaptation step is then implemented in response to this determination of a failure, and the model is re-trained so as to no longer consider the photovoltaic panel as operating in degraded mode, even if one or more components of this photovoltaic panel are defective and induce a decrease in terms of electricity production.

In one variant (not represented in this FIG. 5), the adaptation is performed only after a certain number of failures is reached (e.g., after steps S540 to S575 (selection “COMP”) are repeated n times (with n>1).

Then, step S585 is implemented during which an alert is generated according to which at least one component of said energy production device 100, 100ᵢ is defective. In one particular mode of implementation, this alert message is transmitted, via a communication interface, to a remote monitoring device. As a variant, the electronic supervision device 200 comprises a human-machine interface, such as a touch screen, and the alert message is displayed on this screen. This alert message comprises for example an identification of the defective energy production device, and possibly the defective component(s). Finally, after step S585, the method loops back in step S540.

Returning to step S575, if it is on the other hand determined that the deviations are caused by an evolution in the environmental data of the energy production device 100, 100ᵢ, by a change of at least one sensor for measuring said environmental data, or by a change of at least one component of the energy production device 100, 100ᵢ (selection “ENV”), step S590 is implemented by the electronic supervision device 200. During this step S590, the energy prediction model is re-trained on new environmental data, in order to readjust to the new environmental conditions. Finally, after step S590, the method loops back to step S540.

The disclosed technology has been described so far in the case where the deviation cause model is configured to distinguish two types of deviation causes, but the disclosed technology can indeed be easily generalized by those skilled in the art to the case where more than two types of causes are considered.

Thus, in one particular mode of implementation, the deviation cause model is configured to distinguish either a failure in one or more components of the energy production device 100, 100ᵢ; or an evolution in the environmental data of the energy production device 100, 100ᵢ; or a change of at least one sensor for measuring said environmental data; or a change of at least one component of the energy production device 100, 100ᵢ.

In one particular mode of implementation, the deviation cause model is further configured to determine a type of failure and/or the defective component(s).

Thus, the deviation cause model is for example trained and configured to identify a delamination, a degradation of the anti-reflection layer of the glass or polymer covering the panel, a yellowing of the ethylene-vinyl acetate encapsulant, a generation of hot spots, a formation of cracks within photovoltaic cells, a generation of defects at the interconnections, a failure of a bypass diode or a potential-induced degradation (PID).

The disclosed technology has also been described so far in the case where the energy production device is a photovoltaic panel, but the disclosed technology nonetheless remains applicable in the case where the energy production device is a photodiode, a phototransistor or a wind turbine.

Although the present disclosure has been described with reference to one or more examples, workers skilled in the art will recognize that changes may be made in form and detail without departing from the scope of the disclosure and/or the appended claims.

What is claimed is:

1. An alerting method implemented by an electronic supervision device connected to an energy production device, the method comprising:
determining, by a deviation cause classification model taking as input a history of deviations between a value representative of a prediction of an amount of energy produced by the energy production device and a value representative of an amount of energy actually produced by the energy production device, an occurrence of a failure in at least one component of said energy production device; and
generating an alert according to which at least one component of said energy production device is defective.

2. The alerting method according to claim 1, including determining the value representative of the prediction of the amount of energy produced by the energy production device using an energy prediction model.

3. The alerting method according to claim 1, wherein the history of deviations comprises only deviations greater than a first value.

4. The alerting method according to claim 1, including determining, by the deviation cause classification model, whether the deviations are caused by an evolution in environmental data of the energy production device, by a change of at least one sensor for measuring said environmental data, by a change of at least one component of the energy production device, or by a failure in at least one component of said energy production device.

5. The alerting method according to claim 1, including determining, by the deviation cause classification model, a type of failure and/or said at least one defective component.

6. The alerting method according to claim 1, further comprising producing an adaptation of the deviation cause classification model based on a re-training of the deviation cause classification model.

7. The alerting method according to claim 2, further comprising:
determining, by said deviation cause classification model, that new deviations are caused by an evolution in environmental data of the energy production device, a change of at least one sensor for measuring said environmental data and/or a change of at least one component of the energy production device; and
re-training the energy prediction model.

8. The alerting method according to claim 1, including determining, by an energy prediction model, the value representative of the prediction of the amount of energy produced by the energy production device and determining a size of the history based on the deviation cause classification model.

9. The alerting method according to claim 1, including:
determining the value representative of the prediction of the amount of energy produced by the energy production device by an energy prediction model; and
training the energy prediction model from environmental data sets of said energy production device and from values representative of an amount of energy actually produced by the energy production device considering said environmental data sets, the training of the energy prediction model being implemented when none of the components of said energy production device is defective or considered to be defective.

10. The alerting method according to claim 1, further comprising training of the deviation cause classification model from a plurality of histories of deviations between a value representative of a prediction of an amount of energy produced by the energy production device and a value representative of an amount of energy actually produced by the energy production device, each of the histories of the plurality of histories being associated with a label corresponding to a cause of said deviations.

11. An electronic supervision device configured to monitor an energy production device, the electronic supervision device comprising a processor configured to:
determine, by a deviation cause classification model taking as input a history of deviations between a value representative of a prediction of an amount of energy produced by the energy production device and a value representative of an amount of energy actually produced by the energy production device, an occurrence of a failure in at least one component of said energy production device; and
generate an alert according to which at least one component of said energy production device is defective.

12. The electronic supervision device according to claim 11, wherein the processor is configured to determine the value representative of the prediction of the amount of energy produced by the energy production device using an energy prediction model.

13. The electronic supervision device according to claim 11, wherein the history of deviations comprises only deviations greater than a first value.

14. The electronic supervision device according to claim 11, wherein the processor is configured to determine, by the deviation cause classification model, whether the deviations are caused by an evolution in environmental data of the energy production device, by a change of at least one sensor for measuring said environmental data, by a change of at least one component of the energy production device, or by a failure in at least one component of said energy production device.

15. The electronic supervision device according to claim 11, wherein the processor is configured to determine, by the deviation cause classification model, a type of failure and/or said at least one defective component.

16. The electronic supervision device according to claim 11, wherein the processor is configured to produce an adaptation of the deviation cause classification model based on a re-training of the deviation cause classification model.

17. The electronic supervision device according to claim 12, wherein the processor is configured to:
determine, by said deviation cause classification model, that new deviations are caused by an evolution in environmental data of the energy production device, a change of at least one sensor for measuring said environmental data and/or a change of at least one component of the energy production device; and
re-train the energy prediction model.

18. The electronic supervision device according to claim 11, wherein the processor is configured to determine, by an energy prediction model, the value representative of the prediction of the amount of energy produced by the energy production device and determine a size of the history based on the deviation cause classification model.

19. The electronic supervision device according to claim 11, wherein the processor is configured to:
determine the value representative of the prediction of the amount of energy produced by the energy production device by an energy prediction model; and
train the energy prediction model from environmental data sets of said energy production device and from values representative of an amount of energy actually produced by the energy production device considering said environmental data sets, the training of the energy prediction model being implemented when none of the components of said energy production device is defective or considered to be defective.

20. A computer-readable medium comprising program instructions for the implementation of an alerting method when said program is executed by a processor of an electronic supervision device connected to an energy production device, the method comprising:
determining, by a deviation cause classification model taking as input a history of deviations between a value representative of a prediction of an amount of energy produced by the energy production device and a value representative of an amount of energy actually produced by the energy production device, an occurrence of a failure in at least one component of said energy production device; and
generating an alert according to which at least one component of said energy production device is defective.
